(19) United States
(12) Patent Application Publication
(10) Pub. No.: US 2017/0331336 A1
(43) Pub. Date: Nov. 16, 2017

(54) STATOR CORE FOR ROTATING ELECTRICAL MACHINE, ROTATING ELECTRICAL MACHINE, AND METHOD OF MANUFACTURING ROTATING ELECTRICAL MACHINE

(71) Applicant: Mitsubishi Electric Corporation, Tokyo (JP)

(72) Inventors: Hiroki HAYASHI, Tokyo (JP); Ken OGINO, Tokyo (JP); Hisashi OTSUKA, Tokyo (JP)

(73) Assignee: Mitsubishi Electric Corporation, Tokyo (JP)

(21) Appl. No.: 15/532,359

(22) PCT Filed: Dec. 2, 2014
(86) PCT No.: PCT/JP2014/081859

§ 371 Date: Jun. 1, 2017

(51) Int. Cl. H02K 1/18; H02K 1/16

(52) U.S. Cl. CPC H02K 1/185; H02K 1/16; H02K 1/187

(57) ABSTRACT

A stator core for a rotating electrical machine includes core segments each including a stack of at least one first core member and at least one second core member. The first core member has an arc-shaped first yoke, a first tooth protruding from an inner peripheral side of an arc of the first yoke, a recessed portion provided at a first end of the first yoke, and a protruding portion provided at a second end of the first yoke. The second core member has an arc-shaped second yoke having both linear-shaped ends, and a second tooth protruding from an inner peripheral side of an arc of the second yoke. The recessed portions and the protruding portions of the core segments are combined to form an annular structure, and a dimension of the recessed portion in a radial direction of the annular structure is larger than a dimension of the protruding portion in the radial direction of the annular structure.

### FIELD

The present invention relates to an annular stator core for a rotating electrical machine, the annular stator core being plural core segments combined together. The invention also relates to the rotating electrical machine, and a method of manufacturing the rotating electrical machine.

### BACKGROUND

For rotating electrical machines used for various purposes, an annular stator core is classified into a circular core and a segmented core. The circular core is formed by stacking single-piece electromagnetic steel sheets extending in a direction along the circumference of the stator cores. The segmented core is made by segmenting the single-piece electromagnetic steel sheets in the direction along the circumference of the stator cores and stacking the segmented sheets together to form cores, and then assembling the cores together.

The rotating electrical machines used for vehicle power steering, industrial machine servos, and elevators require small cogging torque and small torque pulsation under load. The roundness of the stator cores formed of the segmented cores is determined during the assemblage, unlike the stator cores formed of the circular cores. A reduction in the roundness of the inner diameter of the stator core makes the magnetic flux non-uniform, which leads to the cogging torque. To reduce the cogging torque of the rotating electrical machine using the segmented-core stator core, the roundness of the inner diameter of the stator core needs to be improved.

Improving the roundness of the inner diameter of the stator core requires a high-precision manufacturing equipment. Patent Literature 1 and Patent Literature 2 propose a method of reducing the cogging torque by improving the roundness of the inner diameter of the stator core.

### CITATION LIST

### Patent Literature

Patent Literature 1: JP 2008-131679 A

Patent Literature 2: JP 2006-187176 A

### SUMMARY

### Technical Problem

The inventions taught in Patent Literature 1 and Patent Literature 2 improve the roundness of the inner diameter of the stator core by providing gaps at connections between the core segments so that the gaps between the core segments accommodate errors in dimensions of the core segments when the core segments are integrated to form the stator core. For the inventions described in Patent Literature 1 and Patent Literature 2, however, the gaps can increase the magnetic reluctance, thereby reducing the magnetic properties of the stator core.

To suppress the effect of reduction in magnetic properties, the invention described in Patent Literature 1 provides laps between the axially overlying lamination members of the adjacent core segments. The laps serve as paths for magnetic flux, thereby suppressing the effect on the characteristics of the rotating electrical machine. Unfortunately, the iron loss occurring due to the magnetic flux flowing in the radial direction can increase the loss and thus reduce the motor characteristics.

An object of the present invention is to provide a stator core for a rotating electrical machine, the stator core being capable of reducing the cogging torque of the rotating electrical machine while suppressing the reduction in magnetic properties and loss.

### Solution to Problem

To solve the above problem and achieve the object, the present invention provides a rotating electrical machine comprising: a plurality of core segments each comprising a stack of at least one first core member and at least one second core member, the at least one first core member having an arc-shaped first yoke, a first tooth protruding from an inner peripheral side of an arc of the first yoke, a recessed portion provided at a first end of the first yoke, and a protruding portion provided at a second end of the first yoke, and the at least one second core member having an arc-shaped second yoke having both linear-shaped ends, and a second tooth protruding from an inner peripheral side of an arc of the second yoke, wherein the recessed portions and the protruding portions of the plurality of core segments are combined to form an annular structure, and a dimension of the recessed portion in a radial direction of the annular structure is larger than a dimension of the protruding portion in the radial direction of the annular structure.

### Advantageous Effect of Invention

The present invention can provide the stator core for the rotating electrical machine, the stator core being capable of reducing the cogging torque of the rotating electrical machine while suppressing the reduction in magnetic properties and loss.

### BRIEF DESCRIPTION OF DRAWINGS

FIG. 1 is a perspective view of a rotating electrical machine according to an embodiment.

FIG. 2 is a cross-sectional view illustrating the rotating electrical machine according to the embodiment cut along a plane parallel to a rotation axis and passing through the rotation axis.

FIG. 3 is a view taken in a direction of arrows A-A in FIG. 2.

FIG. 4 is a plan view of a stator core according to the embodiment.

FIG. 5 is a perspective view of a first core member according to the embodiment.

FIG. 6 is a plan view of the first core member according to the embodiment.

FIG. 7 is a perspective view of a second core member according to the embodiment.

FIG. 8 is a plan view of the second core member according to the embodiment.

FIG. 9 is a perspective view of a core segment according to the embodiment.

FIG. 10 is a perspective view of a core segment according to the embodiment.

FIG. 11 is an enlarged view of combined core segments according to the embodiment.

FIG. 12 is an enlarged view of combined core segments according to the embodiment.

FIG. 13 is an enlarged view of combined core segments according to the embodiment.

FIG. 14 is a flowchart of a method of manufacturing the rotating electrical machine according to the embodiment.

FIG. 15 is a view illustrating the method of manufacturing the rotating electrical machine according to the embodiment.

FIG. 16 is a view illustrating the method of manufacturing the rotating electrical machine according to the embodiment.

FIG. 17 is a view illustrating the method of manufacturing the rotating electrical machine according to the embodiment.

### DESCRIPTION OF EMBODIMENT

Hereinafter, a laser machining device according to an embodiment of the present invention will be described in detail with reference to the drawings. The embodiment described below is not intended to limit the present invention.

### Embodiment

In the embodiment, a rotating electrical machine is exemplified by a permanent magnet motor. In the embodiment, the rotating electrical machine only needs to have a segmented stator, and may be a switched reluctance motor (SRM), not limited to a permanent magnet motor. The rotating electrical machine is not limited to a motor, that is, an apparatus for generating motive power, and may be a generator for generating electric power.

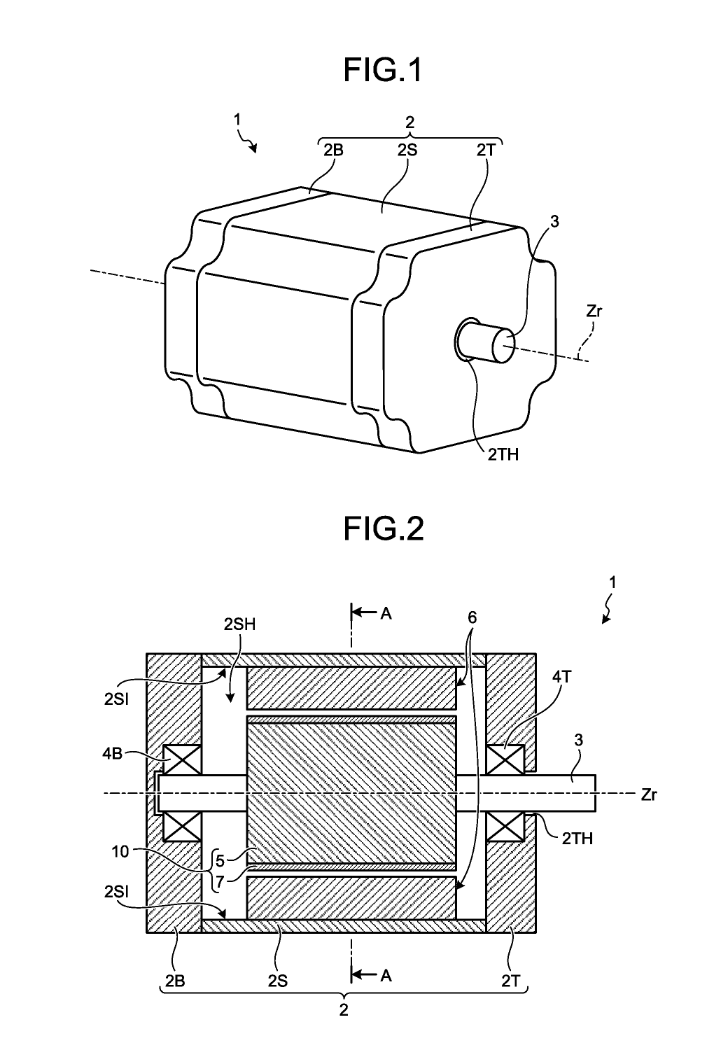

FIG. 1 is a perspective view of the rotating electrical machine according to the embodiment. FIG. 2 is a cross-sectional view illustrating the rotating electrical machine according to the embodiment cut along a plane parallel to a rotation axis and passing through the rotation axis. As illustrated in FIG. 1, a rotating electrical machine 1 includes a housing 2 and a shaft 3. As illustrated in FIG. 2, the housing 2 houses a pair of bearings 4T and 4B supporting the shaft 3, a stator 6, and a rotor 10. The rotor 10 includes a rotor core 5 and permanent magnets 7. The shaft 3 is mounted in the rotor more 5, and the permanent magnets 7 are mounted on the rotor core 5. The rotor core 5 is mounted on the shaft 3. The shaft 3 and the rotor 10 rotate on a rotation center axis Zr.

The housing 2 has a tubular side portion 2S, a first flange 2T mounted to one end of the side portion 2S, and a second flange 2B mounted to an opposite end of the side portion 2S. As illustrated in FIG. 2, the side portion 2S has a through hole 2SH extending therethrough in a direction parallel to the rotation center axis Zr of the shaft 3 and the rotor 10. In the embodiment, the side portion 2S is in a shape of quadrangular prism having its four corners having convex surfaces protruding toward the rotation center axis Zr. The shape of the side portion 2S is not limited to this shape.

The stator 6 is mounted on an inner surface 2SI of the side portion 2S. The inner surface 2SI of the side portion 2S has a circular cross section when cut along a plane orthogonal to the rotation center axis Zr. The stator 6 is disposed in the through hole 2SH of the side portion 2S. The rotor 10 is disposed inside the stator 6. The through hole 2SH of the side portion 2S is closed by the first flange 2T mounted to the one end of the side portion 2S and the second flange 2B mounted to the opposite end. The stator 6 and the rotor 10 are housed in a space surrounded by the side portion 2S, the first flange 2T, and the second flange 2B. That is, the stator 6 and the rotor 10 are housed in the through hole 2SH.

The first flange 2T has a hole 2TH. The shaft 3 on which the rotor core 5 is mounted extends through the hole 2TH. The bearing 4T is mounted in the hole 2TH of the first flange 2T. The bearing 4B is mounted in the second flange 2B. Since the shaft 3 has one end portion and an opposite end portion that are supported by the pair of bearings 4T and 4B as described above, the shaft 3 and the rotor 10 are supported by the first flange 2T and the second flange 2B via the pair of bearings 4T and 4B. The pair of bearings 4T and 4B are exemplified by ball bearings, but are not limited to them.

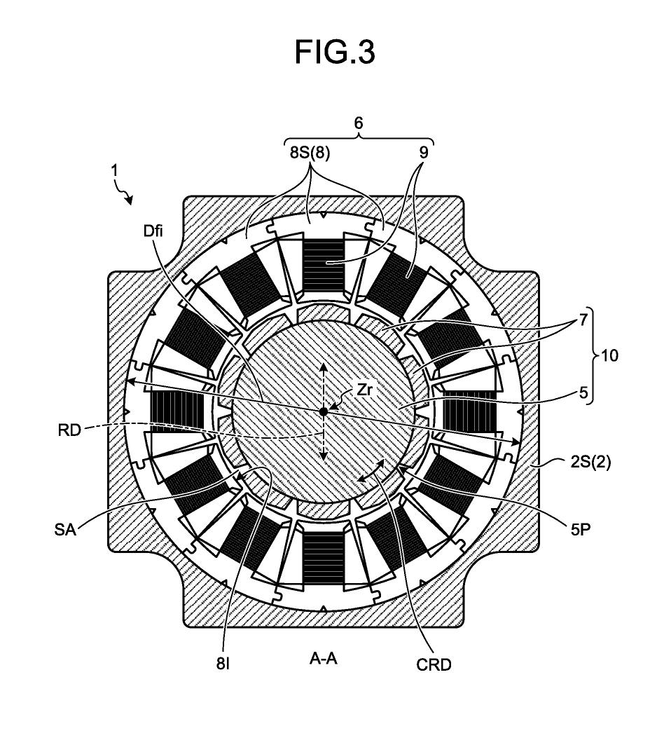

FIG. 3 is a view taken in a direction of arrows A-A in FIG. 2. FIG. 3 illustrates a cross section of the rotating electrical machine 1 cut along a plane orthogonal to the rotation center axis Zr, as viewed in the direction of arrows A in FIG. 2. The stator 6 includes a stator core 8 that is a stator core for the rotating electrical machine, and windings 9 around teeth of the stator core 8. The stator core 8 has an annular structure formed by combining a plurality of core segments 8S. In the embodiment, the stator core 8 is formed of twelve core segments 8S. The number of core segments 8S forming the stator core 8 is not limited.

The rotor 10 is disposed radially inwardly of the stator core 8 that is the annular structure. The radial direction shown by arrows RD in FIG. 3 is a direction orthogonal to the rotation center axis Zr of the rotor 10. The rotor core 5 of the rotor 10 is a structure of a cylindrical shape. The rotor core 5 is formed by stacking a plurality of disks of electromagnetic steel sheets of a magnetic substance. A plurality of permanent magnets 7 is mounted on an outer peripheral surface 5P of the rotor core 5. The N and S poles of the plurality of permanent magnets 7 are disposed alternately along a direction CRD along the circumference of the rotor core 5. In the embodiment, the rotor 10 has ten permanent magnets 7. The number of permanent magnets 7 of the rotor 10 is not limited.

The permanent magnets 7 are mounted on the rotor core 5 by bonding. The way of mounting the permanent magnets 7 on the rotor core 5 is not limited to this. In the embodiment, the permanent magnets 7 are mounted on the outer peripheral surface 5P of the rotor core 5. Alternatively, holes extending through the rotor core 5 in the direction of the rotation center axis Zr may be provided, such that the permanent magnets 7 can be mounted in the holes.

A gap SA is provided between the rotor core 5 and an inner peripheral portion 81 of the stator core 8. Magnetic flux of the permanent magnets 7 is produced in the gap SA. The rotor 10 is rotated by torque produced due to the interaction between magnetic flux produced by the permanent magnets 7 and magnetic flux produced by the windings 9. Next, the stator core 8 will be described in more detail.

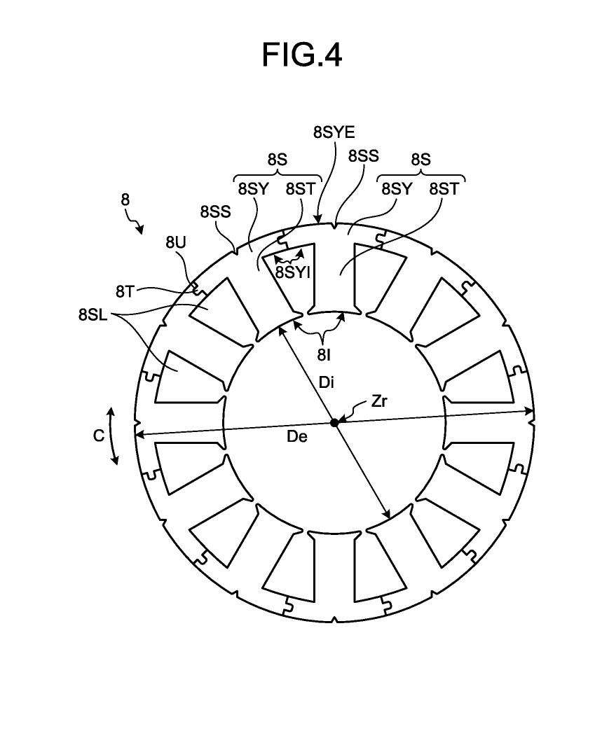

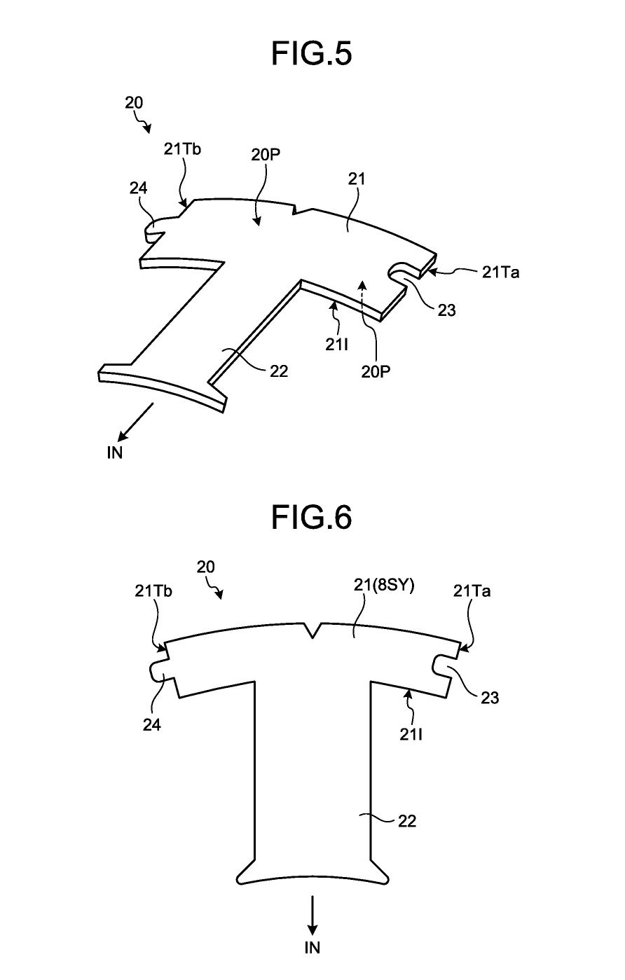

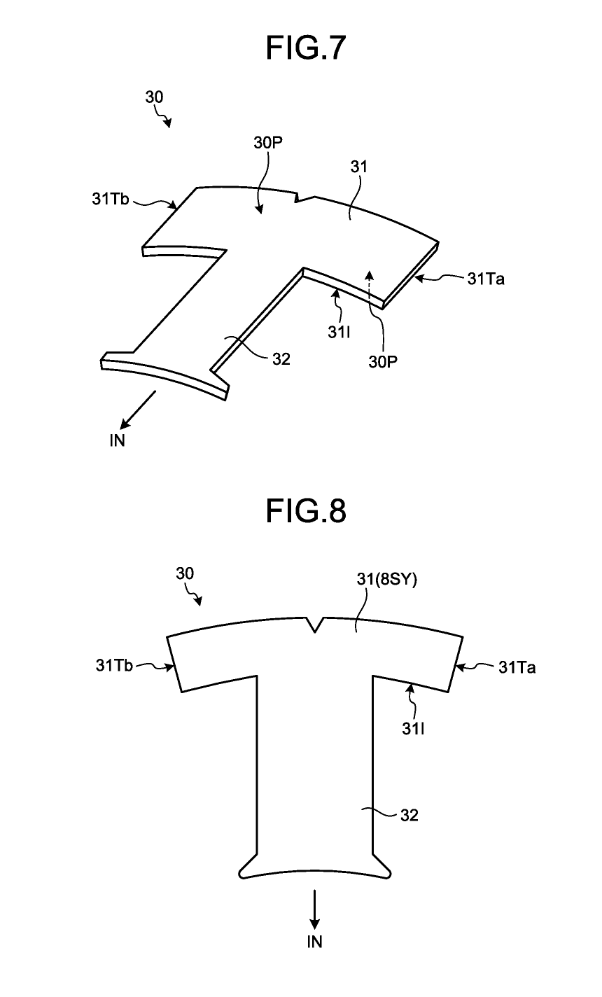

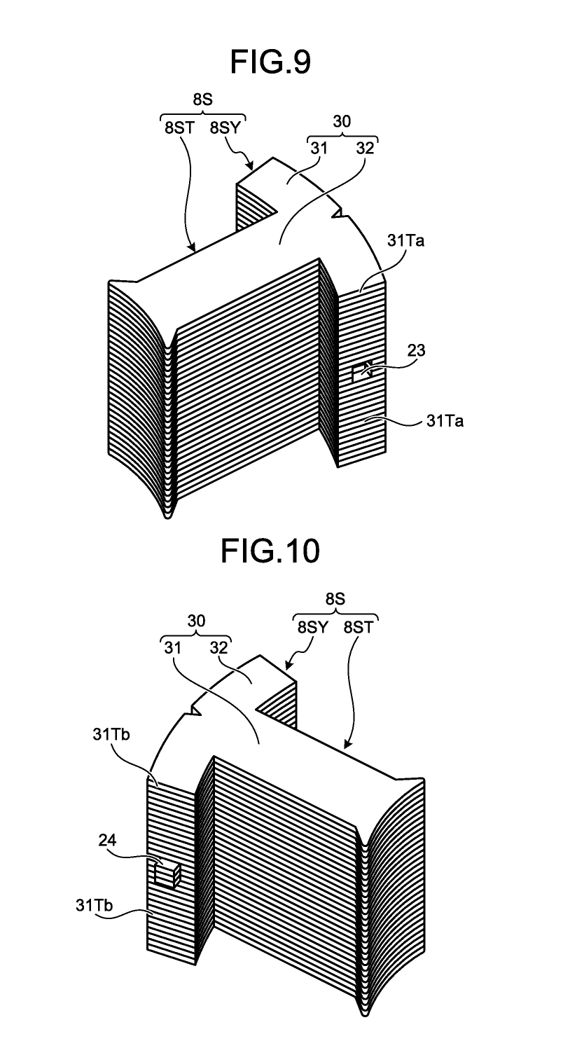

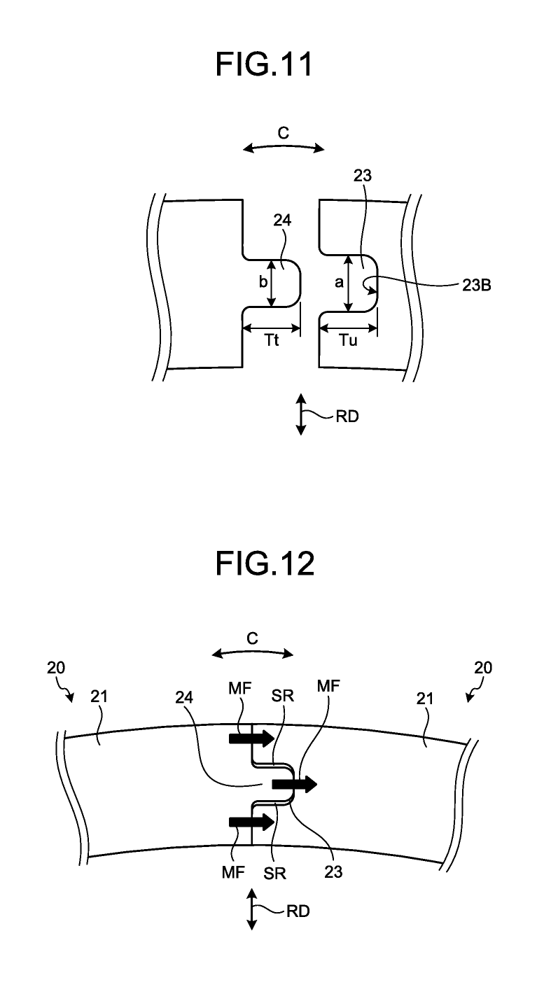

FIG. 4 is a plan view of a stator core according to the embodiment. FIG. 5 is a perspective view of a first core member according to the embodiment. FIG. 6 is a plan view of the first core member according to the embodiment. FIG. 7 is a perspective view of a second core member according to the embodiment. FIG. 8 is a plan view of the second core member according to the embodiment. FIGS. 9 and 10 are perspective views of core segments according to the embodiment. FIG. 11 is an enlarged view of the combined core segments according to the embodiment. An arrow denoted as reference letters IN in FIGS. 5 to 8 points towards the center of the stator core 8, that is, the rotation center axis Zr.

As illustrated in FIG. 4, the plurality of core segments 8S forming the stator core 8 that is the annular structure includes yokes 8SY, teeth 8ST, notches 8SS, recessed portions 8U, and protruding portions 8T. The shape of the yokes 8SY as viewed from a direction of the rotation center axis Zr is an arc shape. The teeth 8ST protrude from the side of inner peripheral portions 8SYI of the arcs of the yokes 8SY toward the rotation center axis Zr. The notches 8SS are provided in outer peripheral portions 8SYE of the arcs of the yokes 8SY. The recessed portion 8U is provided at one end of the yoke 8SY. The protruding portion 8T is provided at an opposite end of the yoke 8SY.

The outer peripheral portion 8SYE of the arc of the yoke 8SY has an arc shape. The radius of curvature of the outer peripheral portion 8SYE is slightly larger than the radius of the inner surface 2SI of the side portion 2S illustrated in FIG. 3. That is, the diameter De of the outer peripheral portions 8SYE of the stator core 8 is slightly larger than the diameter Dfi of the inner surface 2SI of the side portion 2S illustrated in FIG. 3. This structure allows the stator core 8 to be mounted in the side portion 2S of the housing 2 by shrink fitting.

An inner diameter Di of the stator core 8 is the length of a line segment passing through the rotation center axis Zr having both end points located on the surfaces of the inner peripheral portions 81 of the stator core 8. Depending on the assembly accuracy of the core segments 8S, the stator core 8S can have different inner diameters Di for different portions thereof in a direction C along the circumference of the stator core 8. The smaller the variations in the inner diameter Di of the stator core 8 among the portions of the stator core 8 in the direction C along the circumference of the stator core 8, the higher the roundness of the inner diameter Di.

When the stator core 8 is mounted in the side portion 2S of the housing 2, the notches 8SS engage protruding portions provided on the inner surface 2SI of the side portion 2S illustrated in FIGS. 2 and 3 to position the stator core 8 and reduce a displacement of the stator core 8 in the direction along the circumference. In the embodiment, the core segments 8S have the notches 8SS, but the notches 8SS are not indispensable for the core segments 8S.

Since the teeth 8ST protrude from the side of the inner peripheral portions 8SYI of the arcs of the yokes 8SY toward the rotation center axis Zr, the shape of the core segments 8S as viewed from the direction of the rotation center axis Zr is a T-shape. The core segments 8S form the stator core 8 of the annular structure with the arc-shaped yokes 8SY combined at their ends. When the plural core segments 8S are combined, the recessed portion 8U provided at the one end of the yoke 8SY is combined with the protruding portion 8T provided at the opposite end of the adjacent yoke 8SY. Combining the recessed portion 8U of the core segment 8S and the protruding portion 8T of the adjacent core segment 8S suppresses the displacement of the core segments 8S of the stator core 8 in the direction of the rotation center axis Zr and the radial direction that is the direction orthogonal to the rotation center axis Zr.

In the embodiment, the stator core 8 has the twelve teeth 8ST. A space between the adjacent teeth 8ST and 8ST is a slot 8SL. In the embodiment, thus, the stator core 8 has twelve slots 8SL. The stator core 8 has the windings 9 illustrated in FIG. 3 around the teeth 8ST of the core segments 8S. The numbers of teeth 8ST and slots 8SL are not limited to twelve, and are changed appropriately according to the specifications of the rotating electrical machine 1.

The core segment 8S of the stator core 8 is a stack of at least one first core member 20 illustrated in FIGS. 5 and 6 and at least one second core member 30 illustrated in FIGS. 7 and 8. The first core member 20 has an arc-shaped first yoke 21, a first tooth 22 protruding from the side of an inner peripheral portion 21I of the arc of the first yoke 21, a recessed portion 23 provided at a first end 21Ta of the first yoke 21, and a protruding portion 24 provided at a second end 21Tb of the first yoke 21. The second core member 30 has an arc-shaped second yoke 31 and a second tooth 32 protruding from the side of an inner peripheral portion 311 of the arc of the second yoke 31. The second yoke 31 has both linear-shaped ends 31Ta and 31Tb. Hereinafter, the end 31Ta of the second yoke 31 is referred to as a first end 31Ta as appropriate, and the end 31Tb is referred to as a second end 31Tb as appropriate.

The first core member 20 and the second core member 30 are both plate-shaped members made of an electromagnetic steel sheets of a magnetic substance. Surfaces orthogonal to thickness directions of the first core member 20 and the second core member 30 that are the plate-shaped members are defined as a surface 20P and a surface 30P. Since the first tooth 22 of the first core member 20 protrudes from the side of the inner peripheral portion 21I of the arc of the first yoke 21 toward the rotation center axis Zr, the shape of the first core member 20 as viewed from the direction orthogonal to the surface 20P is a T-shape. Likewise, since the second tooth 32 of the second core member 30 protrudes from the side of the inner peripheral portion 311 of the arc of the second yoke 31 toward the rotation center axis Zr, the shape of the second core member 30 as viewed from the direction orthogonal to the surface 30P is a T-shape.

The first core member 20 has the recessed portion 23 provided at the first end 21Ta of the first yoke 21, and the protruding portion 24 provided at the second end 21Tb of the first yoke 21. The recessed portion 23 and the protruding portion 24 are not provided at the first end 31Ta and the second end 31Tb of the second yoke 31 of the second core member 30. Thus, the first end 31Ta and the second end 31Tb of the second yoke 31 are both linear-shaped when the second core member 30 is viewed from the direction orthogonal to the surface 30P.

When first core members 20 and second core members 30 are stacked, the surfaces 20P contact one another or the surface 20P and the surface 30P contact one another. Stacking the first core members 20 and second core members 30 forms the core segment 8S illustrated in FIGS. 9 and 10. The first yokes 21 of the first core members 20 and the second yokes 31 of the second core members 30 are stacked to provide the yoke 8SY of the core segment 8S. The first teeth 22 of the first core members 20 and the second teeth 32 of the second core members 30 are stacked to provide the tooth 8ST of the core segment 8S. As described above, the windings 9 illustrated in FIG. 3 are placed around the teeth 8ST of the core segments 8S. Thus, the windings 9 are placed around the first teeth 22 of the first core members 20 and the second teeth 32 of the second core members 30.

The core segment 8S is manufactured by stacking at least one first core member 20 and at least one second core member 30, and tightening the stacked first and second core members 20, 30 together. Alternatively, the core segment 8S may be manufactured by riveting, screwing, welding or bonding the stacked first and second core members 20, 30. The rotor core 5 is manufactured in the same manner as the core segments 8S.

In the embodiment, as illustrated in FIGS. 9 and 10, a plurality of the second core members 30, a plurality of the first core members 20, and a plurality of the second core members 30 are stacked in this order to form the core segment 8S. In other words, the core segment 8S is formed with a group of stacked first core members 20 interposed between two groups of stacked second core members 30. The core segment 8S is not limited to this structure, and may be formed by interposing at least one first core member 20 between at least two second core members 30. The direction in which the first core members 20 and the second core members 30 are stacked is a direction parallel to the rotation center axis Zr of the rotating electrical machine 1. Hereinafter, the direction in which the first core members 20 and the second core members 30 are stacked is referred to as a stacking direction as appropriate.

The core segment 8S has a structure in which at least one first core member 20 is sandwiched between at least two second core members 30. Therefore, the recessed portion 23 and the protruding portion 24 of the core segment 8S are formed between the second core members 30 and 30 located at both ends of the core segment 8S in the direction of the stacking of the first core member 20 and the second core members 30. When the plural core segments 8S are combined together such that the protruding portions 24 fit in the recessed portions 23, thus, the second core members 30, which are located at the both ends of the core segment 8S in the stacking direction, prevent the core segments 8S from moving in the stacking direction.

The recessed portions 8U and the protruding portions 8T of the core segments 8S are preferably provided in the same level in the stacking direction. This can prevent displacement of both ends of the stator core 8 in the direction parallel to the rotation center axis Zr. Although the recessed portions 8U and the protruding portions 8T are provided in the central portion of the core segment in the stacking direction in the embodiment, they need do not have to be provided in the central portion in the stacking direction as long as they are in the same level in the stacking direction. For example, the recessed portion 8U and the protruding portion 8T may be provided at one end of the core segment 8S in the stacking direction.

The stator core 8 is the annular structure formed by combining the recessed portions 8U and the protruding portions 8T of the plural core segments 8S. As illustrated in FIG. 11, a dimension a of the recessed portion 23 of the first core member 20 in the radial direction RD of the stator core 8 is larger than a dimension b of the protruding portion 24 in the radial direction RD of the stator core 8. This structure allows the core segments 8S to shift in the radial direction RD of the stator core 8 when the plural core segments 8S are combined to form the stator core 8.

It is preferable that the following formula holds: a−b>M−N where M is the maximum value of the inner diameter Di of the stator core 8, and N is the minimum value of the inner diameter Di. This ensures that variation in the inner diameter Di of the stator core 8 is accommodated by the recessed portions 23 and the protruding portions 24 of the core segments 8S.

A dimension Tu of the recessed portion 23 of the first core member 20 in the direction C along the circumference of the stator core 8 is larger than a dimension Tt of the protruding portion 24 in the direction C along the circumference of the stator core 8. This structure enables the protruding portion 24 of the core segment 8S to avoid contacting the bottom 23B of the recessed portion 23 of the adjacent core segment 8S when the plural core segments 8S are combined together. As a result, the first ends 21Ta and 31Ta and the second ends 21Tb and 31Tb of the core segments 8S and 8S adjacent to each other when the plural core segments 8S are combined together contact to reduce the magnetic reluctance, thus improving the magnetic properties of the stator core 8.

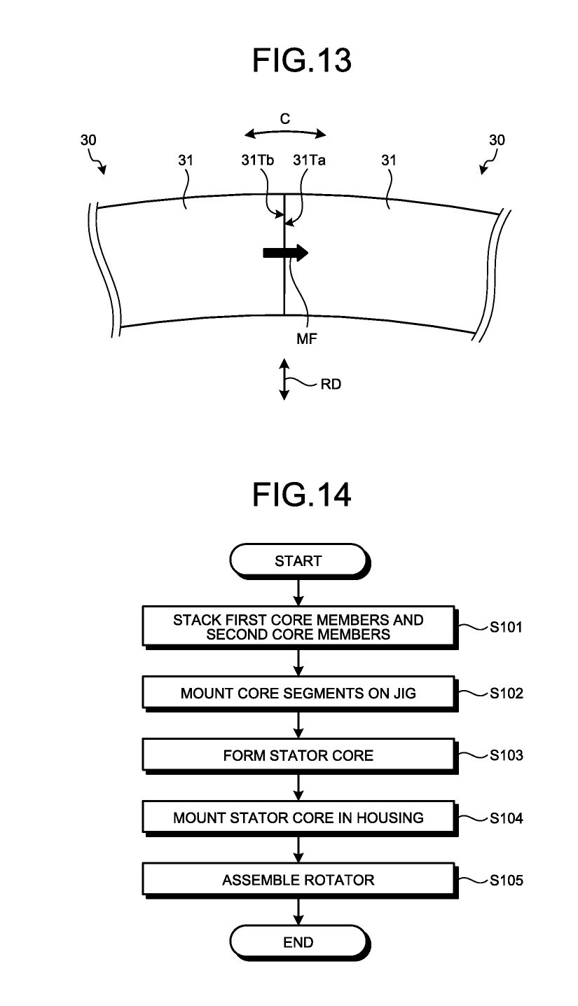

FIGS. 12 and 13 are enlarged views of the combined core segments according to the embodiment. FIG. 12 illustrates a state where first core members 20 are combined together, and FIG. 13 illustrates a state where second core members 30 are combined together. Arrows MF in FIGS. 12 and 13 indicate the flow of magnetic flux. When the roundness of the inner diameter Di of the stator core 8 is reduced, the magnetic flux density distribution in the gap SA illustrated in FIG. 3 becomes non-uniform, so that cogging torque occurs when the rotating electrical machine 1 functions as a motor.

When the recessed portions 23 and the protruding portions 24 of the core segments 8S formed by stacking the first core members 20 and the second core members 30 are combined together, gaps SR are formed in the radial direction RD in the cross sections of the core segments 8S, as illustrated in FIG. 12. To form the stator core 8, the plural core segments 8S are set on an outer peripheral portion of a cylindrical jig so that the plural core segments 8S can be combined in an annular shape, or more specifically, in a ring shape. Then, the gaps SR produce play in the radial direction RD between the adjacent core segments 8S. When set on the outer peripheral portion of the cylindrical jig, thus, the core segments 8S are displaced in the radial direction so that the inner diameter Di of the stator core 8 conforms to the shape of the outer peripheral portion of the jig. As a result, the roundness of the inner diameter Di of the stator core 8 is improved, thus suppressing and reducing the cogging torque of the rotating electrical machine 1.

As illustrated in FIG. 13, the second core member 30 does not have the recessed portion 23 and the protruding portion 24 of the first core member 20 illustrated in FIG. 12. Thus, the linear-shaped first end 31Ta of the second core member 30 contacts the linear-shaped second end 31Tb of the adjacent the second core member 30. As a result, magnetic reluctance at combined portions of the second core members 30 is reduced, thus improving the magnetic properties of the stator core 8.

In the stator core 8, the flow of magnetic flux in the rotation center axis Zr direction and the radial direction RD of magnetic flux occurs only between the recessed portions 23 and the protruding portions 24. The recessed portions 23 and the protruding portions 24 of the first core members 20, or the recessed portions 8U and the protruding portions 8T of the core segments 8S are part of the connections between the adjacent core segments 8S. Therefore, the stator core 8 can suppress the flow of magnetic flux in the rotation center axis Zr direction and the radial direction RD of magnetic flux, and thus suppress the occurrence of iron loss. This enables the motor 1 including the stator core 8 to reduce the energy consumption. Next, a method of manufacturing a rotating electrical machine including a method of manufacturing a stator core will be described.

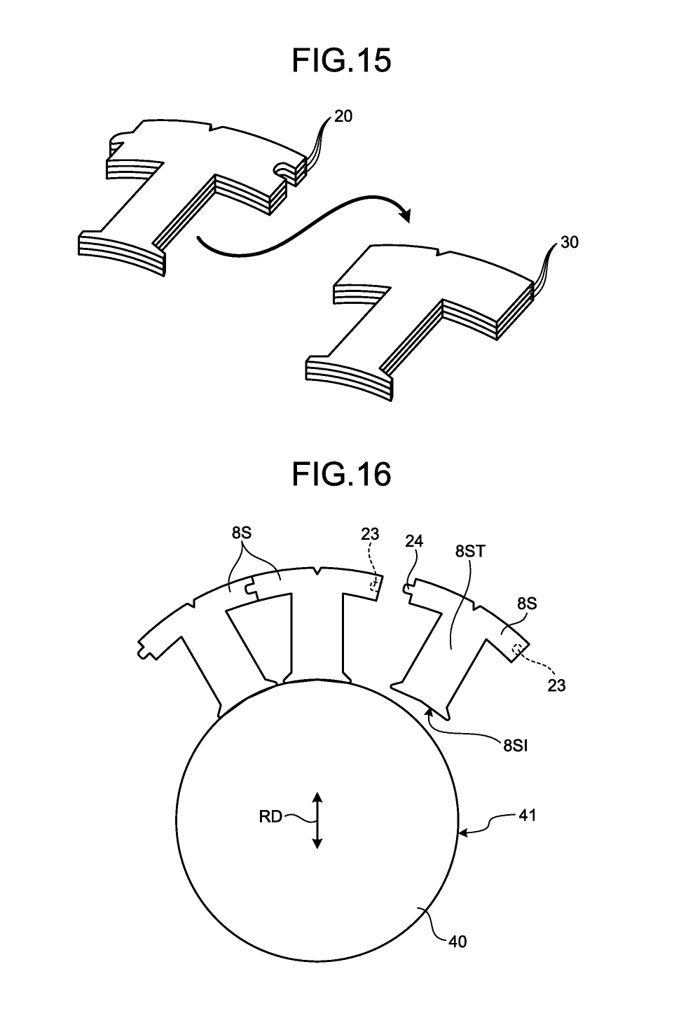

FIG. 14 is a flowchart of a method of manufacturing a rotating electrical machine according to the embodiment. FIGS. 15 to 17 are views illustrating the method of manufacturing the rotating electrical machine according to the embodiment. In step S101, as illustrated in FIG. 15, a plurality of first core members 20 and second core members 30 are stacked. This step forms the core segments 8S.

Next, the process proceeds to step S102, in which, as illustrated in FIG. 16, the core segments 8S are mounted on a jig 40. More specifically, the inner peripheral portions 81 of the core segments 8S are set in an annular shape on the outer peripheral portion 41 of the cylindrical jig 40. When the inner peripheral portions 81 of the core segments 8S are mounted on the jig 40, the core segments 8S are displaced radially such that the inner peripheral portions 81 of the core segments 8S conform to the shape of the outer peripheral portion 41 of the jig 40. Since the gaps SR in the radial direction RD are formed between the recessed portions 23 and the protruding portions 24 of the adjacent core segments 8S and 8S, as illustrated in FIG. 12, the connections between the core segments 8S and 8S are also displaced in the radial direction RD to conform to the shape of the outer peripheral portion 41 of the jig 40. This step S103 forms the stator core 8.

The stator core 8, which is formed by combining the plural core segments 8S without requiring screwing or riveting, is easy to disassemble. The easy disassembly facilitates collection of the stator core 8 when the motor 1 is discarded. Further, the stator core 8 is disassembled into the plural core segments 8S that are easy to collect and transport after the disassembly of the stator core 8.

In the embodiment, after the windings 9 illustrated in FIG. 3 are placed around the teeth 8ST of the core segments 8S illustrated in FIG. 4, the plural core segments 8S are combined to form the stator core 8. The windings 9 may be placed around the teeth 8ST after the stator core 8 is formed, or may be placed around the teeth 8ST after the stator core 8 is mounted in the side portion 2S of the housing 2.

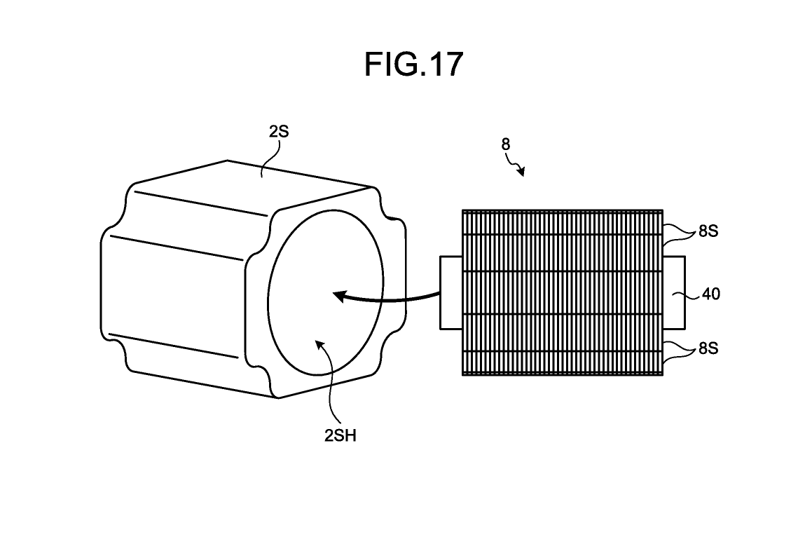

In step S104, as illustrated in FIG. 17, the stator core 8 is mounted in the housing 2, or more specifically, in the side portion 2S of the housing 2. In the embodiment, the stator core 8 mounted on the jig 40 is mounted in the side portion 2S of the housing 2 by shrink fitting. Mounting the stator core 8 in the side portion 2S of the housing 2 by shrink fitting reduces the resin members and an investment in equipment for manufacturing the rotating electrical machine 1. This results in an effect that the environmental load of manufacturing equipment and a manufacturing process itself can be reduced.

In step S104, the side portion 2S is heated until the inner diameter of the through hole 2SH of the side portion 2S becomes larger than the outside diameter of the stator core 8 mounted on the jig 40. Next, the stator core 8 mounted on the jig 40 is disposed in the through hole 2SH of the side portion 2S. Thereafter, the inner diameter of the through hole 2SH becomes small due to the contraction of the side portion 2S as the temperature of the side portion 2S decreases, so that the stator core 8 is secured to the side portion 2S.

When the stator core 8 is secured to the side portion 2S, the jig 40 is removed from the stator core 8. The stator core 8, which is secured to the side portion 2S, provides the roundness of the inner diameter Di of the stator core 8. Since the jig 40 is removed from the stator core 8 after the stator core 8 is secured to the side portion 2S in the embodiment, the roundness of the inside diameter Di of the stator core 8 secured to the side portion 2S is provided.

After the stator core 8 is secured to the side portion 2S, the plurality of windings 9 is connected. Next, in step 5105, the rotor 10 illustrated in FIGS. 1 to 3 is assembled to the side portion 2S of the housing 2. Then, the first flange 2T and the second flange 2B illustrated in FIGS. 1 and 2 are mounted to the side portion 2S, and a terminal for connecting the windings 9 and a controller is mounted, thereby completing the rotating electrical machine 1.

In the embodiment, the number of the first core members 20 is preferably set to a minimum necessary for positioning the core segment 8S and suppressing the displacement of the core segment 8S, and may be one. This can minimize the gaps SR illustrated in FIG. 12 and the gaps between the protruding portions 24 and the bottoms 23B of the recessed portions 23 illustrated in FIG. 11. As a result, the increase in the iron loss of the stator core 8 is suppressed and the magnetic reluctance is further reduced, so that the magnetic properties can be further improved.

One first core member 20 and one second core member 30 have one first tooth 22 and one second tooth 32, respectively, in the embodiment, but are not limited to this. One first core member 20 and one second core member 30 may have two or more first teeth 22 and two or more second teeth 32, respectively, as long as the condition that the plural core segments 8S form the stator core 8 is satisfied. This can reduce the number of core segments 8S, thus facilitating the manufacturing of the stator core 8.

The configuration described in the above embodiment shows an example of the subject matter of the present invention, and can be combined with another known art, and can be partly omitted or changed without departing from the scope of the present invention.

### REFERENCE SIGNS LIST

1 rotating electrical machine, 2 housing, 2S side portion, 2SI inner surface, 2TH hole, 3 shaft, 5 rotor core, 6 stator, 7 permanent magnet, 8 stator core, inner peripheral portion, 8S core segment, 8SL slot, 8ST tooth, 8SY yoke, 8SYE outer peripheral portion, 8SYI inner peripheral portion, 8T, 24 protruding portion, 8U, recessed portion, 9 winding, 10 rotor, 20 first core member, 21 first yoke, 21Ta, 31Ta first end, 21Tb, 31Tb second end, 22 first tooth, 30 second core member, 31 second yoke, 32 second tooth, 40 jig, 41 outer peripheral portion, SR gap, Zr rotation center axis.

1. A stator core for a rotating electrical machine, the stator core comprising:
a plurality of core segments each comprising a stack of at least one first core member and at least one second core member,
the at least one first core member having a first yoke of a shape including an arc, a first tooth protruding from an inner peripheral side of the first yoke, a recessed portion provided at a first end of the first yoke, and a protruding portion provided at a second end of the first yoke, and
the at least one second core member having a second yoke of a shape including an arc and having both linear-shaped ends, and a second tooth protruding from an inner peripheral side of the second yoke, wherein
the recessed portions and the protruding portions of the plurality of core segments are combined to form an annular structure, and a dimension of the recessed portion in a radial direction of the annular structure is larger than a dimension of the protruding portion in the radial direction of the annular structure, and
the protruding portion and the recessed portion contact each other in a circumferential direction of the annular structure.

2. The stator core for the rotating electrical machine according to claim 1, wherein, in each of the core segments, the at least one first core member is sandwiched between at least two of the second core members.

3. The stator core for the rotating electrical machine according to claim 1, wherein a following formula holds: a−b>M−N where M is a maximum value of an inner diameter of the annular structure, N is a minimum value of the inner diameter, a is the dimension of the recessed portion in the radial direction of the annular structure, and b is the dimension of the protruding portion in the radial direction of the annular structure.

4. A rotating electrical machine comprising:
the stator core for the rotating electrical machine according to claim 1;
windings placed around the stack of the first and second teeth;
a housing holding the stator core for the rotating electrical machine; and
a rotor disposed radially inwardly of the stator core for the rotating electrical machine.

5. A method of manufacturing a rotating electrical machine, the method comprising:
manufacturing the stator core for the rotating electrical machine according to claim 1, wherein
manufacturing the stator core comprises:
stacking at least one first core member and at least one second core member to form a core segment, the at least one first core member having a first yoke of a shape including an arc, a first tooth protruding from an inner peripheral side of the first yoke, a recessed portion provided at a first end of the first yoke, and a protruding portion provided at a second end of the first yoke, and the at least one second core member having a second yoke of a shape including an arc and having both linear-shaped ends, and a second tooth protruding from an inner peripheral side of the second yoke;
forming an annular stator core for the rotating electrical machine by disposing, on an outer side of a cylindrical jig, a plurality of the core segments with the recessed portions and the protruding portions being combined together; and
mounting, in a housing, the stator core for the rotating electrical machine mounted on the jig.

6. The method of manufacturing the rotating electrical machine according to claim 5, wherein the stator core for the rotating electrical machine is mounted in the housing by shrink fitting.
